(19) United States
(12) Patent Application Publication
(10) Pub. No.: US 2009/0055931 A1
(43) Pub. Date: Feb. 26, 2009

(54) DEVICE AND METHOD FOR DETECTING VULNERABILITY OF WEB SERVER USING MULTIPLE SEARCH ENGINES

(76) Inventors: Min Sik KIM, Daejeon (KR); Jong Moon LEE, Daejeon (KR); Jung Gil PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/056,339

(22) Filed: Mar. 27, 2008

(30) Foreign Application Priority Data
Aug. 21, 2007 (KR) 10-2007-0084110

(51) Int. Cl. G06F 21/00

(52) U.S. Cl. 726/25

(57) ABSTRACT

Provided are a web server vulnerability detecting device and method which detect vulnerability of a plurality of high-performance web servers in real-time using a plurality of search engines simultaneously and automatically provide the updated detailed information on detected vulnerability. The device includes: a web server examination module for requesting a plurality of different search engines to examine a file with a likelihood of vulnerability, in response to an input search word, and receiving from the search engines URLs of web servers on which the file with a likelihood of vulnerability is located; an optimal information collection module for optimizing the URLs of the web servers received from the search engines to obtain optimal information; a web server vulnerability detecting module for detecting vulnerability of a web server corresponding to the optimal information; and a vulnerability information collection module for collecting and providing the latest detailed information on the detected vulnerability.

According to the device and method, damage caused by web server intrusions can be reduced, the vulnerability of web servers can be more precisely detected using a plurality of different search engines, and the updated latest detailed information can be provided.

### CROSS-REFERENCE TO RELATED APPLICATION

This application claims priority to and the benefit of Korean Patent Application No. 2007-84110, filed Aug. 21, 2007, the disclosure of which is incorporated herein by reference in its entirety.

### BACKGROUND

1. Field of the Invention

The present invention relates to a web server vulnerability detecting device and method and, more particularly, to a web server vulnerability detecting device and method for detecting vulnerability of a web server and obtaining detailed information using a plurality of different search engines simultaneously at a remote site.

2. Discussion of Related Art

In recent times, web server vulnerability has been problematic and vulnerability of many web application programs has been detected. However, the number of intrusions on web servers is ever-increasing. In particular, it is difficult to manage web servers with large-scale registration of domain names or web servers of which contents are frequently changing.

This is because most web servers are not easily managed and contain many vulnerabilities. In order to solve this problem, a tool capable of periodically detecting vulnerability to a web server intrusion has been developed.

However, since a conventional vulnerability detecting tool provides information on vulnerability from its own vulnerability database, it provides no detailed information on the latest vulnerability to Internet-based threats that is updated in real-time.

Therefore, it is necessary to develop a new tool that can detect vulnerability of web servers with large-scale domain registration or web servers with frequently changing web content and provides the updated detailed information on the vulnerability with a minimum of time and effort.

### SUMMARY OF THE INVENTION

The present invention is directed to a web server vulnerability detecting device and method which exactly can detect vulnerability of web servers in real-time at a remote site using a plurality of search engines simultaneously, and automatically provide the updated detailed information on the detected vulnerability.

The web server vulnerability detecting device may be installed in a position physically separated from a web server and detects the vulnerability of the web server in an environment in which the device can gain access to the web server via the Internet.

The web server vulnerability detecting device according to the present invention examines vulnerability of web servers at a remote site using a plurality of search engines simultaneously, performs a logic OR on results received from the search engines with different search performances to obtain optimal information, determines if a web server corresponding the optimal information has vulnerability, and collects and provides the latest detailed information on the detected vulnerability. Thus, the web server vulnerability detecting device detects the vulnerability of the web server in real-time and simultaneously, automatically provides the updated detailed information on the detected vulnerability.

One aspect of the present invention provides a web server vulnerability detecting device including: a web server examination module for requesting a plurality of different search engines to examine a file with a likelihood of vulnerability, in response to an input search word, and receiving from the search engines URLs of web servers on which the file with a likelihood of vulnerability is located; an optimal information collection module for optimizing the URLs of the web servers received from the search engines to obtain optimal information; a web server vulnerability detecting module for detecting vulnerability of a web server corresponding to the optimal information; and a vulnerability information collection module for collecting and providing the latest detailed information on the detected vulnerability.

The device may further include an informing module for informing a manager of the web server vulnerability detecting device of information on all operating errors and informing a manager of the vulnerability detected web server of the latest information on the vulnerability

Another aspect of the present invention provides a method for detecting vulnerability of a web server, the method including: requesting a plurality of different search engines to examine a file with a likelihood of vulnerability, in response to an input search word; receiving from the search engines URLs of web servers on which the file with a likelihood of vulnerability is located and optimizing them to obtain optimal information; determining if a web server corresponding to the optimal information has vulnerability; and searching the latest detailed information on the vulnerability, based on a vulnerability database or by using the plurality of different search engines when it is determined that the web server has the vulnerability.

The method may further include informing the web server that has been determined to have the vulnerability of the latest detailed information on the vulnerability.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of a web server vulnerability detecting device using a plurality of different search engines according to an exemplary embodiment of the present invention; and

FIG. 2 is a flowchart illustrating a method of detecting vulnerability of a web server using a plurality of different search engines according to an exemplary embodiment of the present invention.

### DETAILED DESCRIPTION OF EMBODIMENTS

The present invention will now be described more fully with reference to the accompanying drawings, in which exemplary embodiments of the invention are shown. This invention may, however, be embodied in different forms and should not be construed as limited to the embodiments set forth herein.

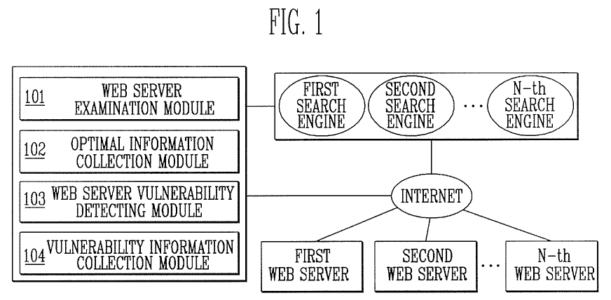

FIG. 1 is a block diagram of a web server vulnerability detecting device using a plurality of different search engines according to an exemplary embodiment of the present invention.

Referring to FIG. 1, the web server vulnerability detecting device, which employs the plurality of different search engines simultaneously, is located in an Internet-accessible environment and normally operates in the environment in which a typical web browser is operable.

The web server vulnerability detecting device using the plurality of different search engines includes a web server examination module 101, an optimum information collection module 102, a web server vulnerability detecting module 103, and a module 104 for collecting the latest detailed information on vulnerability (hereinafter, a vulnerability information collection module 104).

The web server examination module 101 requests the plurality of different search engines to examine files having a likelihood of vulnerability, in response to an input search word including a packet with a known vulnerable point. Thereafter, the web server examination module 101 receives Uniform Resource Locators (URLs) of web servers which include the files having the likelihood of vulnerability from the search engines. The optimal information collection module 102 collects and combines the URLs of the web servers examined by the search engines with different search performances and optimizes the URLs of the web servers having the likelihood of vulnerability using a logic operation, such as a logic OR.

The web server vulnerability detecting module 103 parses the URL of the web server to prepare for detection of vulnerability, sends a query for detecting vulnerability to the web server with the likelihood of vulnerability, and detects vulnerability of the web server based on an answer to the query or a return message. As a result, when it is determined that there is vulnerability in the web server, the vulnerability information collection module 104 collects the updated latest information on the vulnerability based on a vulnerability database or by using the plurality of different search engines simultaneously.

The above-described web server examination module 101, the optimal information collection module 102, the web server vulnerability detecting module 103, and the vulnerability information collection module 104 can be embodied in personal computers (PCs) so that ordinary users can detect vulnerability of web servers.

Also, the web server vulnerability detecting device using the search engines may further include a module (not shown) for providing information on all operating errors of the web server vulnerability detecting device to a device manager and providing detailed information on the vulnerability to the corresponding web server manager.

Meanwhile, the search engines according to the present invention include web services that search websites with content including a search word to be searched among enormous amount of web documents. The search engines may be servers equipped with search devices.

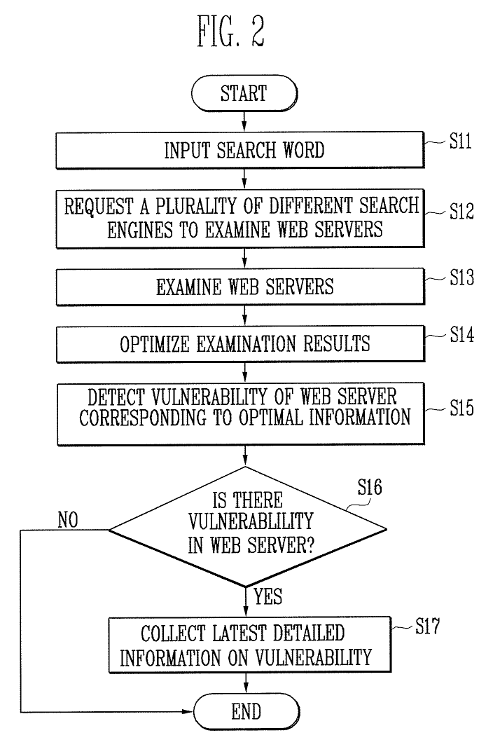

FIG. 2 is a flowchart illustrating a web server vulnerability detecting method according to an exemplary embodiment of the present invention, which is performed using the device shown in FIG. 1.

Referring to FIG. 2, a designated vulnerability search word is input in step S11. In response to the search word, the web server examination module 101 requests a plurality of different search engines to examine a file having a likelihood of vulnerability in step S12. In step S13, the plurality of different search engines provides URLs of web servers in which the file with a likelihood of vulnerability is located. In step S14, the optimal information collection module 102 performs a logic operation, such as a logic OR, on results from the search engines and obtains optimal information. In step S15, the web server vulnerability detecting module 103 receives the optimal information and detects vulnerability of the web server with the likelihood of vulnerability. In this case, the web server vulnerability detecting module 103 sends a query to the web server with the likelihood of vulnerability based on the optimal information and receives an answer to the query from the corresponding web server. Thereafter, the web server vulnerability detecting module 103 determines if the corresponding web server has vulnerability based on the received answer in step S16.

As a result, when it is determined that the web server has vulnerability in step S16, the vulnerability information collection module 104 collects the updated latest information on the vulnerability based on a vulnerability database or by using the plurality of different search engines simultaneously in step S17. Although not shown in the drawings, it is possible to optimize detailed information examined in step S13. Thus, the optimized latest detailed information on the vulnerability of the web server is obtained and a vulnerability detecting process is finished. Meanwhile, when it is determined that the web server has no vulnerability in step S16, the current vulnerability detecting process skips step S17 and ends.

As described above, the present invention provides a device and method for detecting vulnerability of a web server using a plurality of different search engines simultaneously. The web server vulnerability detecting device normally operates in the environment in which a web browser is operable at a remote site. The web server vulnerability detecting device examines a web server with a likelihood of vulnerability using the plurality of different search engines simultaneously, optimizes examined information, and detects vulnerability of the corresponding web server based on the optimized information. Thus, the vulnerability of the web server can be detected at maximum efficiency and accuracy. Furthermore, according to the present invention, not only information stored in a vulnerability database but also the latest detailed information on the vulnerability of the web server are simultaneously provided by the plurality of different search engines, so that a manager can promptly take security measures against hacking or intrusion incidents.

In the drawings and specification, there have been disclosed typical preferred embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A web server vulnerability detecting device, comprising:
a web server examination module for requesting a plurality of different search engines to examine a file with a likelihood of vulnerability, in response to an input search word, and receiving from the search engines URLs of web servers on which the file with a likelihood of vulnerability is located;
an optimal information collection module for optimizing the URLs of the web servers received from the search engines to obtain optimal information;
a web server vulnerability detecting module for detecting vulnerability of a web server corresponding to the optimal information; and
a vulnerability information collection module for collecting and providing the latest detailed information on the detected vulnerability.

2. The device according to claim 1, wherein the optimal information collection module obtains the optimal information by performing a logic OR on the URLs of the web servers.

3. The device according to claim 1, wherein the vulnerability information collection module collects and provides the latest information on the detected vulnerability based on a vulnerability database or by using the plurality of different search engines simultaneously.

4. The device according to claim 1, further comprising an informing module for informing a manager of the web server vulnerability detecting device of information on all operating errors and informing a manager of the vulnerability detected web server of the latest information on the vulnerability.

5. A method for detecting vulnerability of a web server, the method comprising:
requesting a plurality of different search engines to examine a file with a likelihood of vulnerability, in response to an input search word;
receiving from the search engines URLs of web servers on which the file with a likelihood of vulnerability is located and optimizing them to obtain optimal information;
determining if a web server corresponding to the optimal information has vulnerability; and
searching the latest detailed information on the vulnerability, based on a vulnerability database or by using the plurality of different search engines when it is determined that the web server has the vulnerability.

6. The method according to claim 5, wherein the receiving from the search engines URLs of web servers comprises performing a logic OR on the URLs of the web servers.

7. The method according to claim 5, wherein the determining if the web server corresponding to the optimal information has vulnerability comprises:
transmitting a query for detecting vulnerability to the web server corresponding to the optimal information;
receiving an answer to the query or a return message from the web server; and
determining if the web server has vulnerability based on the answer or the return message.

8. The method according to claim 5, wherein after the latest detailed information on the vulnerability is searched using the plurality of different search engines, the latest detailed information is optimized.

9. The method according to claim 5, further comprising informing the web server that has been determined to have the vulnerability of the latest detailed information on the vulnerability.
